(19) United States
(12) Patent Application Publication
(10) Pub. No.: US 2022/0152613 A1
(43) Pub. Date: May 19, 2022

(54) STORAGE DEVICE FOR STORING A GAS MEASURING DEVICE, STORAGE DEVICE AND GAS DETECTOR SYSTEM AND METHOD FOR STORING THE GAS DETECTOR

(71) Applicant: Dräger Safety AG & Co. KGaA, Lubeck (DE)

(72) Inventors: Andreas NAUBER, Lubeck (DE); Michael SICK, Lubeck (DE); Marie-Isabell MATTERN-FRÜHWALD, Lubeck (DE)

(21) Appl. No.: 17/527,772

(22) Filed: Nov. 16, 2021

(30) Foreign Application Priority Data
Nov. 17, 2020 (DE) 10 2020 130 289.4

(51) Int. Cl. B01L 7/00; G01N 27/26; B01L 1/00

(52) U.S. Cl. CPC B01L 7/00; G01N 27/26; B01L 2200/18; B01L 2300/1822; B01L 1/00

(57) ABSTRACT

A storage device (20) stores a gas measuring device (10). The gas measuring device (10) has at least one electrochemical sensor (11) for measuring the concentration of a gas. The storage device (20) has a temperature control device (21) for controlling the temperature of the electrochemical sensor (11). A system (40) includes such a storage device (20) and a gas measuring device (10) that is stored therein. The temperature control device (21) is arranged at the storage device (20) such that the temperature control device (21) is located opposite the electrochemical sensor (11) of the gas measuring device (10) during the temperature control. A process for storing a gas measuring device (10) in such a storage device (20) includes controlling the temperature of the electrochemical sensor (11) of the gas measuring device (10) by the temperature control device (21) during the storage.

### CROSS REFERENCE TO RELATED APPLICATIONS

This application claims the benefit of priority under 35 U.S.C. § 119 of German Application 10 2020 130 289.4, filed Nov. 17, 2020, the entire contents of which are incorporated herein by reference.

### TECHNICAL FIELD

The present invention pertains to a storage device for storing a gas measuring device, to a system comprising such a storage device and such a gas measuring device as well as to a process for storing the gas measuring device in such a storage device.

### TECHNICAL BACKGROUND

Electrochemical sensors in gas measuring devices contain, as a rule, a liquid electrolyte. The liquid electrolyte may contain, for example, organic components and/or inorganic salts and be soluble in water. As an alternative, the liquid electrolyte may contain inorganic acids or bases. Slow evaporation of the electrolyte takes place in the case of electrolytes containing organic components during storage in ambient air. Evaporation of the water from the electrolyte takes place in case of the other electrolytes described under certain ambient conditions.

The electrochemical sensors have a diffusion opening, through which the gas to be measured flows into the interior of the sensor. The electrolyte or the water contained in it can escape through this open diffusion surface rapidly and in large quantities as a gas into the environment. The consequence is in both cases that the sensitivity of the electrochemical sensor may decrease.

In this case, the properties of the electrochemical sensors change with varying ambient conditions. Especially great changes take place under harsh ambient conditions, e.g., at very low or very high atmospheric humidity and/or high temperatures. The sensitivity of the electrochemical sensors may decrease and the response times of the electrochemical sensors may become longer. Many gas measuring devices, especially those containing organic components, can therefore only be stored for a short time under harsh ambient conditions.

A liquid electrolyte with a low vapor pressure for a gas measuring device, in which the evaporation of water from an electrochemical sensor of the gas measuring device is slowed down, is known from US 2010/0236924 A1. The drawback of such liquid electrolytes with low vapor pressure is, however, that these do not usually possess all the properties that the electrochemical sensor is required to possess. Thus, they usually have only a low ion conductivity and offer only a poor wetting of electrodes and of the diaphragm in the electrochemical sensor.

### SUMMARY

Based on this state of the art, a basic object of the present invention is to provide a solution, by means of which the long-term operability of gas measuring devices with electrochemical sensors can be preserved with simple and cost-effective devices. In particular, a possibility shall be created for improving the possibility of storing gas measuring devices with electrochemical sensors under harsh ambient conditions as well.

The above object is accomplished by a storage device having the features of the invention as well as by a system having the features according to the invention as well as by a process having the features according to the invention. Further features and details of the present invention appear from the description and from the drawings. Features and details that are described in connection with the storage device also apply, of course, in connection with the system according to the present invention and with the process according to the present invention and also vice versa, so that reference is or can always mutually be made to the individual aspects of the present invention concerning the disclosure.

According to a first aspect of the present invention, the object is accomplished by a storage device for storing a gas measuring device, wherein the gas measuring device has at least one electrochemical sensor for measuring the concentration of a gas, and wherein the storage device has a temperature control device for controlling the temperature of the electrochemical sensor.

The storage means, in particular, a process, in which the gas measuring device is not being used, i.e., the concentration of the gas is not determined during the storage time. The gas measuring device may be stored at a distance from a location of use in order not to expose the electrochemical sensor to harsh ambient conditions. It is, however, also possible with the storage device according to the present invention to store the gas measuring device at the location of use with the harsh ambient conditions. This is advantageous based on the proximity of the location of use, and the gas measuring devices therefore often remain or must remain at the location of use.

A storage device is defined in this connection as a device in which the gas measuring device can be stored while it is not being used to detect corresponding gases. In other words, a storage device is a special storage location for a gas measuring device that is temporarily not being used.

The temperature control device in the storage device is used according to the present invention to control the temperature of the electrochemical sensor. Temperature control in this case means cooling and/or heating. Depending on the ambient conditions prevailing at the location of the gas measuring device, the area directly surrounding the electrochemical sensor can be influenced by cooling or heating. This is advantageous with regard to the electrolyte contained in the electrochemical sensor. For example, the temperature control device can cool the electrochemical sensor in case of very high ambient temperatures in order to protect the liquid electrolyte in the electrochemical sensor from harmful effects of the very high ambient temperature. The temperature control device can likewise heat the electrochemical sensor in case of very low ambient temperatures in order to protect the electrolyte in the electrochemical sensor from harmful effects of the very high ambient temperature or to bring it to operating temperature.

A temperature control surface of the temperature control device may be arranged and/or dimensioned such that only the temperature of the electrochemical sensor of the gas measuring device is controlled. The temperature control surface is preferably at least as large as the diffusion area of the electrochemical sensor or it preferably has a larger area, which can also cover a plurality of sensors, because a temperature control of the entire gas measuring device is not necessary. As a result, the temperature can be controlled in an energy-saving manner and compact and cost-effective temperature control devices can be used, which provide a low heat output and/or a low cooling output. The temperature control device can be arranged for this purpose at or in the storage device such that the tempering surface of the temperature control device is located opposite the location at which the gas sensor of the gas measuring device is located when the gas measuring device is located in the storage device.

Various temperature control devices, for example, a Peltier element, which can be used for the electrical temperature control of an environment of this element with the use of the thermoelectric Peltier effect, are known to the person skilled in the art.

The temperature control device is preferably configured with a first operating mode for cooling and with a second operating mode for heating. The electrochemical sensor can correspondingly be cooled by means of the first operating mode from a high temperature, as it may prevail in the area surrounding the location of use of the gas measuring device, or from a normal room temperature or ambient temperature under normal ambient conditions to a lower storage temperature. As a result, the liquid electrolyte in the electrochemical sensor is protected from the harmful effects of the high temperature. In addition, the electrochemical sensor can be heated by means of the second operating mode to an operating temperature in order to be immediately ready for use on removal from the storage device. It could happen below the operating temperature that the electrochemical sensor is not fully operable, e.g., it has an excessively low sensitivity or long response times for the target gas.

The storage device may have a control unit. The control unit may be set up to operate the temperature control device optionally in the first operating mode or in the second operating mode. The control unit may be set up, for example, to select the operating mode such that a predefined storage temperature is set or a predefined temperature difference from the ambient temperature is set. The control unit may further be set up to set the cooling rate in the first operating mode and/or the heating rate in the second operating mode. Further, the control unit may be set up to select an operating mode such that the gas measuring device will reach the operating temperature. The control unit may be connected for this purpose, for example, to an operating device, especially to a time switching unit. The respective operating mode, for example, heating, can be initialized by means of the operating device in order to reach the operating temperature. An operating time, at which the operating temperature shall be reached, can be preset by means of the time switching unit. The control unit may have a memory, in which the predefined storage temperature, temperature difference, heating rate and/or cooling rate as well as functions for the different operating modes are stored, and which can be retrieved by the control unit.

Further, the temperature control device is preferably a Peltier element. The Peltier element may be used both for heating and for cooling. As an alternative, it is also possible to use a refrigeration device (heat pump). However, the Peltier element is especially advantageous because of its energy demand, its compactness and its low costs compared to a refrigerator or other temperature control devices in the present application, which is the cooling of a relatively small electrochemical sensor.

In addition, the storage device is preferably set up to cool the electrochemical sensor during the storage to a predefined storage temperature and especially to maintain the electrochemical sensor at the storage temperature. The storage temperature is the temperature that prevails in the area around the sensor, for example, in the area of the temperature control surface, during the storage. The storage temperature may be an absolute predefined temperature or a temperature difference to be maintained against the ambient temperature. The control unit is set up, in particular, to control the temperature control device correspondingly. The storage device or the gas measuring device may be equipped for this purpose with a temperature sensor, which measures the temperature of the electrochemical sensor. Further, the gas measuring device may have a data interface corresponding to a data interface of the storage device. For example, the temperature of the electrochemical sensor can be transmitted to the storage device by means of the exchange via the data interfaces when the gas measuring device has the temperature sensor. The data interface may be, for example, a physical hardware interface or a wireless interface. The temperature of the electrochemical sensor may, however, also be estimated in a simple manner on the basis of the temperature of the temperature control device, of an experimental data set and/or of a mathematical model. The electrochemical sensor is protected from external ambient effects and its operability is maintained by maintaining the temperature control device at the storage temperature, as a result of which the electrochemical sensor is also maintained at a desired temperature.

Furthermore, it is preferred that the storage device has an operating device or is connected or can be connected to an operating device via a wireless connection of a wireless interface of the storage device, wherein the operating device is set up to initiate a heating of the electrochemical sensor from the storage temperature to an operating temperature during the storage. The operating device may be, for example, a switch, e.g., a pushbutton, in the first case, and, for example, a remote control or a smart phone in the second case. The operating device may now be a time switching unit or have a time switching function, by means of which an operating time, at which the operating temperature shall be reached, can be set. This makes it possible to provide a kind of “wake up” function and is especially advantageous for making the gas measuring device correspondingly ready to operate at predefined work times or shift times of workers, as a result of which waiting times can be avoided.

In addition, it is preferred that the storage device has at least one acoustic and/or visual output device, which is set up to acoustically and/or visually output at least one piece of information concerning the temperature control of the electrochemical sensor. The visual output device may have, for example, one or more lighting devices. The lighting devices may be, for example, of the LED type in order to ensure an especially energy-saving operation. The visual output device may, however, also be, for example, a screen. Detailed data, for example, on the temperature of the electrochemical sensor and/or of the temperature control device, on a state of charge of the gas measuring device and/or on another state of the gas measuring device, for example, the functional state of the electrochemical sensor, can be outputted via the screen. Further, the screen may have an operating functionality by touching the screen (touch functionality) for operating the storage device. The operating device may be implemented by means of the operating functionality based on touching. As an alternative or in addition, the output device may be a speaker or another acoustic output device, which outputs one or more sounds or announcements. The information concerning the temperature control may be, for example, a current cooling operating mode, a current heating operating mode, an operating mode in which the storage temperature, the current temperature of the electrochemical sensor or of the temperature control device are maintained and/or status information, such as that the storage temperature has been reached or that the operating temperature has been reached. The control unit may correspondingly be set up to output such information by means of the output device.

It is especially preferred that the storage device has a charging device for charging an energy supply unit of the gas measuring device. In other words, the storage device can now be called a charging device or charging station, wherein the charging station has the temperature control device and the temperature control function described. As a result, a separate charging station may be dispensed with and temperature control and charging can be carried out at the same time. This reduces the costs and increases the comfort of handling.

Further, it is preferred that the storage device has a testing unit for testing the sensitivity of the gas measuring device and/or that the storage device has a calibrating unit for calibrating or adjusting the gas measuring device. In other words, the storage device may now be called a testing and/or calibrating station, wherein the testing and/or calibrating station has the temperature control device and the temperature control function described. A testing unit is defined as a device by means of which the sensitivity of the gas measuring device, especially the sensitivity of the sensors arranged in the gas measuring device, can be tested. A calibrating unit is defined as a device by means of which the gas measuring device, especially the sensors arranged in the gas measuring device, can be calibrated. The testing unit and the calibrating unit may form a common unit. The testing unit and/or the calibrating unit may be arranged in a common housing of the storage device or outside of the housing of the storage device. In case of external arrangement, the testing unit and/or the calibrating unit may be correspondingly connected via a gas line to the housing of the storage device. By feeding gas to the electrochemical sensor during the storage of said sensor in the storage device, the sensitivity of the sensors can be measured by means of the testing unit, because the gas concentration of the gas being fed is known. Further, the gas measuring device can be calibrated with the calibrating unit by feeding gas to the electrochemical sensor during the storage of the sensor in the storage device, because the gas concentration of the gas being fed is known. The gas may be fed from a corresponding gas container, for example, from a gas cylinder, which is connected to the housing of the storage device. The storage device may have itself gas lines, by means of which the gas can be delivered to the electrochemical sensor.

It is, in addition, preferred that the storage device has a storage shell for storing the gas measuring device and a cap (cover), which is arranged at the storage shell and is movable relative to the storage shell, wherein the temperature control device is arranged in the cap, so that the temperature control device can be moved in the direction of the electrochemical sensor and away from same. The cap may be arranged rotatably and/or displaceably especially relative to the storage shell. The cap may be arranged at the storage device for this purpose, for example, by means of a hinge and/or slidingly on a rail or guide. Rapid arrangement or insertion of the gas measuring device into and removal of the gas measuring device from the storage device is made possible by such an arrangement. The cap may have an actuating mechanism for moving, especially for opening or displacement. The control unit may be set up to actuate the actuating mechanism when the operating temperature is reached in order to move the cap and to release the gas measuring device thereby. As a result, easier access is made possible to the gas measuring device, because the cap does not have to first be moved manually. Further, a worker can thus detect in a simple manner that the operating temperature has been reached and the gas measuring device is ready to use.

According to a second aspect of the present invention, the object described in the introduction is accomplished by a system comprising a storage device according to the present invention and a gas measuring device being stored therein, wherein the temperature control device is arranged at the storage device such that the temperature control device is located opposite and adjacent to the electrochemical sensor of the gas measuring device during the temperature control.

The gas measuring device may also be equipped in this case with at least two or more electrochemical sensors, which are configured to measure different gases. The temperature control device of the storage device may be correspondingly set up to control the temperatures of all electrochemical sensors, or the storage device may have a plurality of temperature control devices, which are set up each for controlling the temperatures of the sensors separately.

A sealing element, which is arranged at least partially around the temperature control device and projects in the direction of the gas measuring device, is arranged at the storage system, which at least partially encloses the electrochemical sensor during the temperature control. The sealing element may also be arranged predominantly or completely around the temperature control device and enclose the electrochemical sensor predominantly or completely during the temperature control. The sealing element may be arranged, in particular, at the cap. The sealing element may be configured, for example, as at least one sealing lip, especially as at least one circular or annular sealing lip. The electrochemical sensor can be insulated at least partially against the surrounding area during the temperature control by means of the projecting sealing element. The temperature control device can control thereby the temperature of the electrochemical sensor in a specific manner. Further, energy losses are reduced.

According to a third aspect of the present invention, the present invention accomplishes the object according to a process for storing a gas measuring device in a storage device according to the present invention, wherein the temperature of the electrochemical sensor of the gas measuring device is controlled by means of the temperature control device during the storage.

In particular, the electrochemical sensor can be cooled during the storage from a use temperature or from an operating temperature to a storage temperature. This may take place by a corresponding actuation of an operating device of the storage device or automatically on insertion of the gas measuring device into the storage device. Further, the electrochemical sensor can be maintained at the storage temperature during the storage. This may also take place automatically. In addition, the electrochemical sensor can be heated during the storage from the storage temperature to the operating temperature. This process may be initiated by an operating device or by a time-switching unit.

The electrochemical sensor is preferably cooled during the storage to a predefined storage temperature and is especially maintained at the storage temperature, the storage temperature being in a range of 1° C. to 8° C. and especially in a range of 2° C. to 5° C. This storage temperature has proved to be especially advantageous for the storage of the ion-conductive electrolyte in the electrochemical sensor, on the one hand, and for the duration of a heating to an operating state, i.e., until the operating temperature is reached.

Further, the electrochemical sensor is preferably heated during the storage from the storage temperature to an operating temperature, in which case the heating rate is in a range of 2 K/minute to 12 K/minute and especially in a range of 3 K/minute to 9 K/minute. The gas measuring device can be made ready for use relatively rapidly at this heating rate without the ion-conductive electrolyte in the electrochemical sensor being damaged.

The system according to the present invention and the process according to the present invention thus have the same advantages that were described in detail in reference to the storage device according to the present invention.

Further aspects of the improvements of the present invention appear from the following description given in connection with some exemplary embodiments of the present invention, which are shown in the figures. All the features and/or advantages appearing from the claims, from the description or from the drawings, including structural details and arrangements in space, may be essential for the present invention both in themselves and in the different combinations as well. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side view of a first exemplary embodiment of a system according to the present invention;

FIG. 2 is a side view of a second exemplary embodiment of a system according to the present invention; and

FIG. 3 is a schematic view concerning an exemplary embodiment of a process according to the present invention.

### DESCRIPTION OF PREFERRED EMBODIMENTS

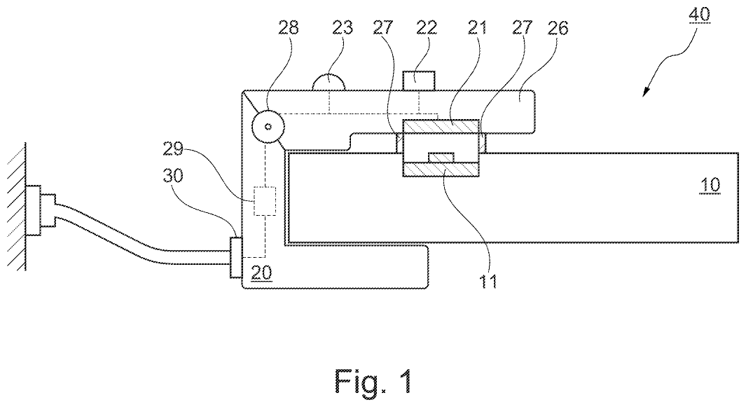

Referring to the drawings, elements having the same function and mode of operation are always designated by the same reference numbers in FIGS. 1 through 3.

FIG. 1 shows a side view of a first exemplary embodiment of a system 40 according to the present invention. The system 40 has a storage device 20 and a gas measuring device 10 stored therein. The storage device 20 has an essentially U-shaped housing in the side view. The housing of the storage device 20 is configured in this case as a clip or as a clamp, which can be fastened to the gas measuring device 20. The storage device 20 may have mounting or fastening devices, not shown, which are configured corresponding to the gas measuring device 10. The storage device 20 may have, for example, one or more groove-like recesses, into which the gas measuring device 10 can be inserted. As a result, an unintended separation of the gas measuring device 10 can be avoided thereby. Further, the storage device 20 may have a data interface, not shown, for coupling with the gas measuring device 10.

The gas measuring device 10 has at least one electrochemical sensor 10 for detecting at least one gas in the surrounding area. The gas measuring device 10 may be set up to measure a gas concentration of the at least one gas to be detected. The electrochemical sensor 11 correspondingly has at least one liquid electrolyte, which has, for example, organic components and/or inorganic salts and/or may be dissolved in water.

The storage device 20 has a housing section and a cap 26 arranged therein in an articulated manner. The housing section has an essentially L-shaped configuration in this exemplary embodiment, but it may also have other shapes. The cap 26 is arranged at the housing section by means of a hinge 28 and can be rotated and/or tilted in the direction of the gas measuring device 10 and away from same. Provisions may be made in this connection for the gas measuring device 20 to be clamped between the cap 26 and the housing section of the storage device 26. A distance between the cap 26 and the housing section may be configured for this purpose corresponding to the thickness of the gas measuring device 10 and/or the hinge 28 may be spring-loaded in order to press the gas measuring device 10 to the housing section by means of the cap 26.

A temperature control device 21 in the form of a Peltier element is arranged in the cap 26 in the direction of the gas measuring device 10. The temperature control device 21 is located opposite and adjacent to the electrochemical sensor 11 during the storage of the gas measuring device 10 in the storage device 20. The temperature control device 21 has a temperature control surface, which may especially be as large as or larger than a sensor surface of the electrochemical sensor 11 in order to make possible a rapid temperature control of the electrochemical sensor 11. The electrochemical sensor 11 is enclosed by a sealing element 27 located at a spaced location from the cap 26. The sealing element 27 is arranged in this case circularly around the temperature control device 21 and is configured as one or more sealing lips.

The temperature control device 21 is controlled by means of a control unit 29 of the storage device 20. The temperature control device 21 has the operating modes heating and cooling. The control unit 29 has corresponding functions for controlling the operating modes. These functions may be stored in a memory of the control unit 29. The storage device 20 further has an operating device 22 and an output device 23. The operating device 22 is configured as a push switch in this exemplary embodiment. The operating device 22 is used to operate the temperature control device. By operating the operating device 22, a signal is outputted to the control unit 29 thereto, which signal initiates a start of an operating mode for storing the gas measuring device 10 and thus for initiating a temperature control of the temperature control device 21 such that the temperature of the electrochemical sensor is controlled such that this temperature will reach a predefined storage temperature. The temperature control of the temperature control device 21 is initiated by a repeated operation of the output device 23 such that the temperature of the electrochemical sensor 11 is controlled to a predefined operating temperature, at which this electrochemical sensor is immediately ready for use. Further, the output device 23 is configured in this exemplary embodiment as a light with two LEDs of different light colors. The control device 29 is set up to allow a red LED of the lamp to light up when the electrochemical sensor 11 does not have the operating temperature and a green LED of the lamp when the electrochemical sensor 11 has the operating temperature.

The storage device 20 according to this exemplary embodiment is supplied with electric power by means of a supply terminal 30 of the storage device 20 and of a power cable connected thereto, as a result of which the temperature control device 21 is operated. As an alternative, the storage device 20 may be equipped, for example, with an energy storage device, for example, with a battery or with a fuel cell, or with a solar cell.

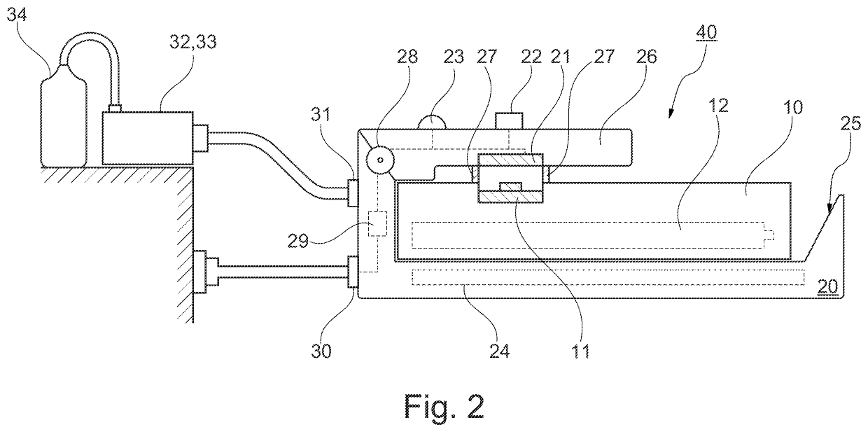

FIG. 2 shows a side view of a second exemplary embodiment of a system 40 according to the present invention. The system 40 has the same configuration in this second exemplary embodiment as the system 40 according to the first exemplary embodiment in respect to the electrochemical sensor 10 of the gas measuring device 10, the operating device 22, the control unit 29, the hinge 28, the supply terminal 30 and the output device 23.

Unlike in the first exemplary embodiment, the storage device 20 of the second exemplary embodiment does, however, have a storage shell 25, in which the gas measuring device 10 is stored. The gas measuring device 10 lies on the storage shell 25 for this purpose. The housing section of the storage device 20 is shaped in this case as a storage shell 25. The storage shell 25 has an upwards extending projection, so that the storage shell 25 is essentially U-shaped. The projection may be in contact with the gas measuring device 10 and prevent the gas measuring device 10 from being displaced. The gas measuring device 10 is thus located securely in the storage device 20.

The storage device 20 and/or the storage shell 25 further have a charging device 24. This charging device 24 is configured in this case as an inductive charging device, which charges an energy supply unit 12 in the form of a power storage device of the gas measuring device 10 during the storage. As an alternative, the charging device 24 may be equipped with a supply terminal, for example, with a jack or with a plug, which is coupled with a corresponding supply terminal, for example, a plug or a jack, of the gas measuring device 10.

Further, the storage device 20 and/or the system 40 have a testing unit 32 and a calibrating unit 33. The testing unit 32 and the calibrating unit 33 are configured in this case as a common device. The testing unit 32 and the calibrating unit 33 are coupled fluidically by means of a gas line to a gas port 31 of the storage device 20 and are thus arranged externally in relation to the storage device 20. As an alternative, they may, however, also be arranged within the housing of the storage device 20. The testing unit 32 and the calibrating unit 33 are coupled fluidically to a gas container 34 in the form of a gas cylinder. The gas container 34 contains the gas to be detected by the electrochemical sensor 11. The cap 26 may have an opening or nozzle, not shown, which is coupled with the gas port 31 and which releases gas in the direction of the electrochemical sensor 11. Further, the gas measuring device 10 may be coupled for information exchange or for control technology to the storage device 20, especially to the control unit 29. Gas can be sent by means of the testing unit to the electrochemical sensor 11, where the gas measuring device 10 measures a concentration and outputs same to the storage device 20. The storage device 20 may correspondingly indicate by means of, for example, an alarm sound or an instruction message at the output device 23, which may be configured for this purpose, for example, as a screen or as a speaker, when the sensitivity or the response time of the gas measuring device 10 is not in a predefined range. Further, gas can be sent by means of the calibrating unit 33 to the electrochemical sensor 11, where the gas measuring device 10 measures a concentration, outputs this same concentration to the storage device 20 and the gas measuring device 10 then calibrates the gas measuring device 10 on the basis of a deviation determined by the calibrating unit 34 on the basis of a known gas concentration in the gas container 34.

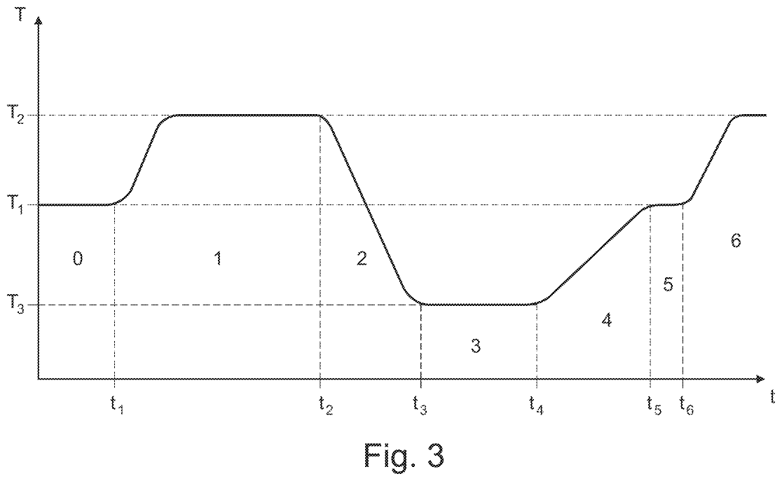

FIG. 3 shows a schematic view of an exemplary embodiment of a process according to the present invention. A temperature-vs-time diagram of the temperature T of the electrochemical sensor 11 of the gas measuring device 10 is shown.

The gas measuring device 10 is stored in the storage device 20 during the operating phase 0. The gas measuring device 10 was brought to the operating temperature T₁ and is immediately ready for use in order to detect a gas at a location of use. The gas measuring device 10 is removed from the storage device 20 by a worker at the time t₁ and is used at the location of use. The location of use is relatively warm, so that the ambient temperature T₂ at the location of use is higher than the operating temperature T₁, which may be, for example, in a range of 15° C. to 25° C., and especially in a range of 18° C. to 22° C. The ambient temperature T₂ may correspondingly be, for example, in a range of 25° C. to 40° C. The temperature of the electrochemical sensor 11 correspondingly rises gradually during phase 1 to the ambient temperature T₂ and it remains at this temperature for the time of the use of the gas measuring device 10. The operability of the electrochemical sensor 11 may decrease in the long term at these elevated temperatures, so that the worker will store the gas measuring device 10 after the use in the storage device 20 at the time t₂. Cooling of the electrochemical sensor 11 by means of the temperature control device 21 is initiated at the storage device 20 during the operating phase 2, as a result of which the electrochemical sensor 11 is cooled to a storage temperature T₃. The storage temperature T₃ may be, for example, in a range of 1° C. to 8° C. If the storage device 20 is equipped with a charging device 24 as it is according to the second exemplary embodiment according to FIG. 2, the energy supply unit 12 of the gas measuring device 10 can be charged at the same time during this phase 2.

When the storage temperature T₃ is reached at the time t₃, the storage temperature T₃ is maintained by the temperature control device 21 in order to avoid possible harmful effects of higher temperatures on the electrochemical sensor 11. Heating of the electrochemical sensor 11 is initiated at a time t₄ by a worker, who would like to use the gas measuring device 10 again, by means of the operating device 22. For this purpose the temperature control device 21 heats the electrochemical sensor 11, for example, at a heating rate in a range of 2 K/minute to 12 K/minute. The operating temperature T₁ of the gas measuring device 10 is finally reached at the time t₅. If the storage device 20 is configured with a testing unit 33 and/or with a calibrating unit 34, as it is according to the second exemplary embodiment according to FIG. 2, the gas measuring device 10 can, moreover, be tested and possibly calibrated during phase 5. The worker then removes the gas measuring device 10 at the time t₆ and uses the gas measuring device 10 at the location of use, where the temperature T of the electrochemical sensor 11 rises again.

It is possible to store and possible to charge the gas measuring device 10 by means of the process according to the present invention at a time during which the gas measuring device 10 was not being used such that the liquid electrolyte in the electrochemical sensor 11 of the gas measuring device 10 was protected from harmful effects of high ambient temperatures. The service life of the electrochemical sensor 11 is thus considerably prolonged. It is thus possible to replace the electrochemical sensor 11 considerably less frequently over the service life of the gas measuring device 10.

While specific embodiments of the invention have been shown and described in detail to illustrate the application of the principles of the invention, it will be understood that the invention may be embodied otherwise without departing from such principles.

### LIST OF REFERENCE CHARACTERS

10 Gas measuring device
11 Electrochemical sensor
12 Energy supply unit
20 Storage device
21 Temperature control device
22 Operating device
23 Output device
24 Charging device
25 Storage shell
26 Cap
27 Sealing element
28 Hinge
29 Control unit
30 Supply terminal
31 Gas port
32 Testing unit
33 Calibrating unit
34 Gas container
40 System
T Temperature of the electrochemical sensor
T₁ Operating temperature
T₂ Ambient temperature
T₃ Storage temperature

What is claimed is:

1. A storage device for storing a gas measuring device, wherein the gas measuring device has at least one electrochemical sensor for measuring a concentration of a gas, the storage device comprising a temperature control device for controlling a temperature of the at least one electrochemical sensor.

2. A storage device in accordance with claim 1, wherein the temperature control device is configured to provide a first operating mode for cooling and a second operating mode for heating.

3. A storage device in accordance with claim 1, wherein the temperature control device comprises a Peltier element.

4. A storage device in accordance with claim 1, wherein the storage device is configured to cool the electrochemical sensor during storage to a predefined storage temperature and to maintain the at least one electrochemical sensor at the storage temperature.

5. A storage device in accordance with claim 4, wherein:
the storage device comprises an operating device or an operating device is operatively connected to the storage device by one or more of a wired connection, a wireless connection and a wireless interface of the storage device; and
the operating device is configured to initiate a heating of the at least one electrochemical sensor from the storage temperature to an operating temperature during the storage.

6. A storage device in accordance with claim 1, further comprising at least one acoustic and/or visual output device, which is configured to acoustically and/or visually output at least one piece of information concerning the temperature control of the at least one electrochemical sensor.

7. A storage device in accordance with claim 1, further comprising a charging device for charging an energy supply unit of the gas measuring device.

8. A storage device in accordance with claim 1, further comprising at least one of a testing unit for testing a sensitivity of the gas measuring device and a calibrating unit for calibrating the gas measuring device.

9. A storage device in accordance with claim 1, further comprising:
a storage shell for storing the gas measuring device; and
a cap arranged at the storage shell and moveable relative to the storage shell, wherein the temperature control device is arranged in the cap, so that the temperature control device is moveable in a direction toward the at least one electrochemical sensor and in a direction away from the at least one electrochemical sensor.

10. A system comprising:
a gas measuring device comprising at least one electrochemical sensor for measuring a concentration of a gas; and
a storage device comprising a temperature control device for controlling a temperature of the electrochemical sensor, the gas measuring device being stored in the storage device, wherein the temperature control device is arranged at the storage device such that the temperature control device is located opposite the at least one electrochemical sensor of the gas measuring device during the temperature control.

11. A system in accordance with claim 10, further comprising a sealing element arranged at least partially around the temperature control device and projecting in a direction of the gas measuring device wherein the sealing element encloses the at least one electrochemical sensor at least partially during the temperature control.

12. A system in accordance with claim 10, wherein the temperature control device is configured to provide a first operating mode for cooling and a second operating mode for heating.

13. A system in accordance with claim 10, wherein the temperature control device comprises a Peltier element.

14. A system in accordance with claim 10, wherein:
the storage device is configured to cool the electrochemical sensor during storage to a predefined storage temperature and to maintain the at least one electrochemical sensor at the storage temperature;
the storage device comprises an operating device or an operating device is operatively connected to the storage device by one or more of a wired connection, a wireless connection and a wireless interface of the storage device; and
the operating device is configured to initiate a heating of the at least one electrochemical sensor from the storage temperature to an operating temperature during the storage.

15. A system in accordance with claim 10, wherein the storage device further comprises an output device configured to provide at least one of an acoustic output and a visual output of information concerning the temperature control of the at least one electrochemical sensor.

16. A system in accordance with claim 10, wherein the storage device further comprises a charging device for charging an energy supply unit of the gas measuring device.

17. A system in accordance with claim 10, further wherein the storage device further comprises one or more of a testing unit configured to testing a sensitivity of the gas measuring device and a calibrating unit configured to calibrate the gas measuring device.

18. A process for storing a gas measuring device in a storage device for storing the gas measuring device, wherein the gas measuring device has at least one electrochemical sensor for measuring a concentration of a gas, the storage device comprising a temperature control device for controlling a temperature of the electrochemical sensor, the process comprising the steps of:
storing the gas measuring device in the storage device; and
controlling a temperature of the at least one electrochemical sensor of the gas measuring device with the temperature control device during the storage.

19. A process in accordance with claim 18, wherein the at least one electrochemical sensor is cooled during the storage to a predefined storage temperature, wherein the storage temperature is in a range of 1° C. to 8° C.

20. A process in accordance with claim 13, wherein:
the at least one electrochemical sensor is heated during the storage from a storage temperature to an operating temperature; and
a heating rate of the heating is in a range of 2 K/minute to 12 K/minute.
